(19) United States
(12) Patent Application Publication
(10) Pub. No.: US 2003/0111022 A1
(43) Pub. Date: Jun. 19, 2003

(54) Pouch for canine excretement

(76) Inventors: David Woolley, Whitby (CA); Bonnie Woolley, Whitby (CA)

Correspondence Address: BIRCH STEWART KOLASCH & BIRCH, PO BOX 747, FALLS CHURCH, VA, 22040-0747, US

(21) Appl. No.: 10/300,825

(22) Filed: Nov. 21, 2002

(30) Foreign Application Priority Data
Nov. 21, 2001 (CA) 2,363,435

(51) Int. Cl. A01K 23/00

(52) U.S. Cl. 119/868

(57) ABSTRACT

The pouch has an elongated mouth for gaining access to the interior of the pouch and a zipper for opening and closing the mouth. One or more cords have loops which extend outwardly from the top of the pouch. A toggle is attached to each cord for increasing and decreasing the size of the loop. The pouch is attached to a leash by first, passing the leash through the opening in each loop and secondly, by tightening the loops around the leash by means of the toggles in order to affix the pouch tightly to the leash so that the pouch does not move on the leash. A cord may also be attached to the handle of the leash should it be difficult to stop the pouch from sliding on the leash.

### FIELD OF THE INVENTION

This invention relates to pouches for holding bags of canine excrement and more particularly to a pouch which may be attached to a leash where it is convenient for carrying bags of excrement collected while a dog is being walked. Being attached to the leash, the pouch does not have to be carried by hand.

### BACKGROUND OF THE INVENTION

At one time dogs were free to roam in urban areas and few persons were concerned with the inevitable consequences of that, namely accumulations of canine excrement on the streets and lawns. Lately however, because of concerns for the environment, municipal councils in more and more cities and towns in North America have passed by-laws which prohibit dog-owners from allowing their dogs to roam freely. In addition those by-laws usually require dog-owners who are walking their dogs to clean up after them.

The usual method of cleaning up canine excrement is to pick it up using a plastic bag and to deposit the bag in the nearest waste bin. Picking up the excrement is disagreeable enough but carrying it can be even more so, particularly where there is no waste bin close by and the excrement must be carried for some time.

We have invented a combination of pouch and several other components for carrying one or more plastic bags containing a dog's excrement. The pouch is attached to a leash and located such that it is close to the dog but not close to the person who is walking the animal. The dog-walker does not therefore have the disagreeable task of carrying the excrement by hand nor does he have to smell it before he disposes of it in a waste bin.

### SUMMARY OF THE INVENTION

Briefly the combination of our invention includes a pouch having oppositely facing front and rear walls and a top and a bottom. The top of the pouch has a plurality of apertures formed therein. The front wall has an elongated mouth for gaining access to the interior of the pouch. The pouch has means for selectively opening and closing the mouth. The combination also includes one or more cords each having a pair of ends and a central portion. The ends of the cord are disposed within the pouch and the central portion is formed into a loop which extends outwardly from the aperture. A toggle is attached to each cord for increasing and decreasing the size of its opening. The pouch is adapted to be attached to a leash by first, passing the leash through the opening in each loop and secondly, by causing each toggle to decrease the size of the opening such that the cord tightly engages the leash thereby preventing the pouch from moving on the leash.

### BRIEF DESCRIPTION OF THE DRAWINGS

The combination of the invention is described with reference to the accompanying drawings in which:

FIG. 1 is a perspective view of the pouch of the invention attached to a dog's leash;

FIG. 2 is an enlarged perspective view of the pouch and leash;

FIG. 3 is an enlarged perspective view of the pouch and leash showing the way in which the pouch is used;

FIG. 4 is a side elevation of a cord and toggle used to attach the pouch to a leash;

FIG. 5 is a perspective view or a second embodiment of the pouch together with a leash and a handle in which the leash retracts; and

FIG. 6 is a perspective view of the pouch of FIG. 5 attached to a dog's leash.

Like reference characters refer to like parts throughout the description of the drawings.

### DESCRIPTION OF PREFERRED EMBODIMENTS

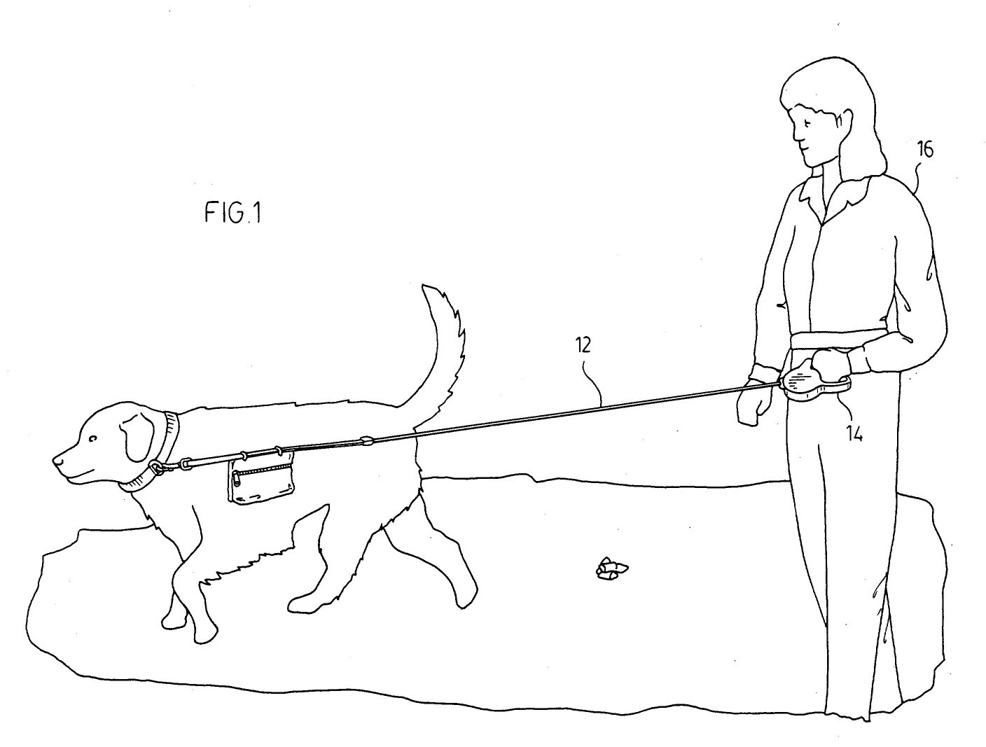

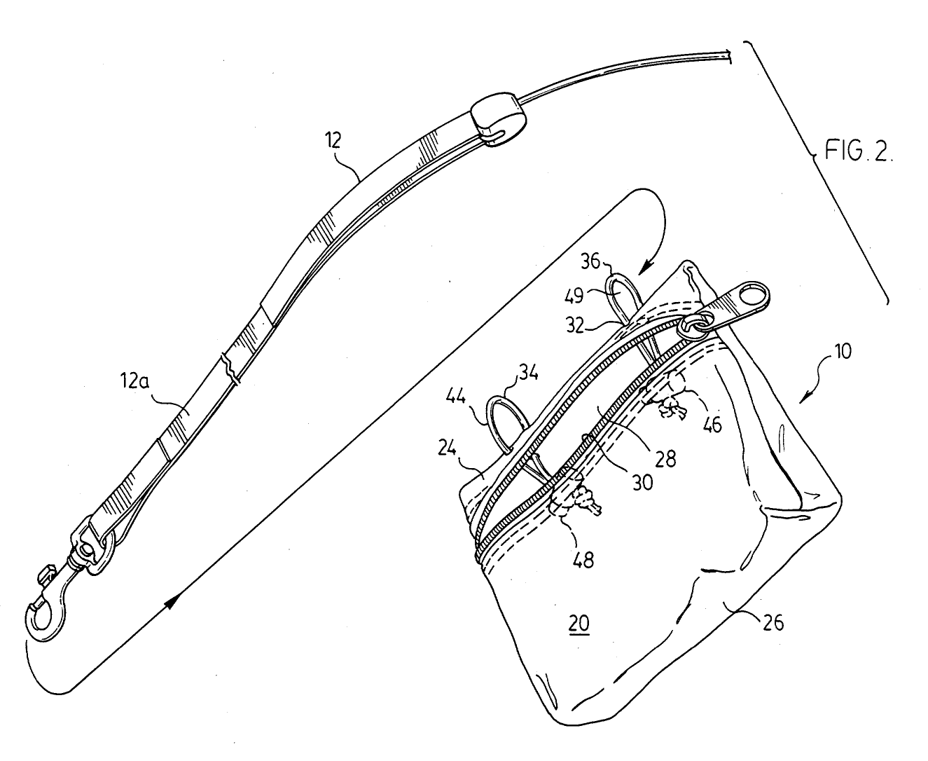

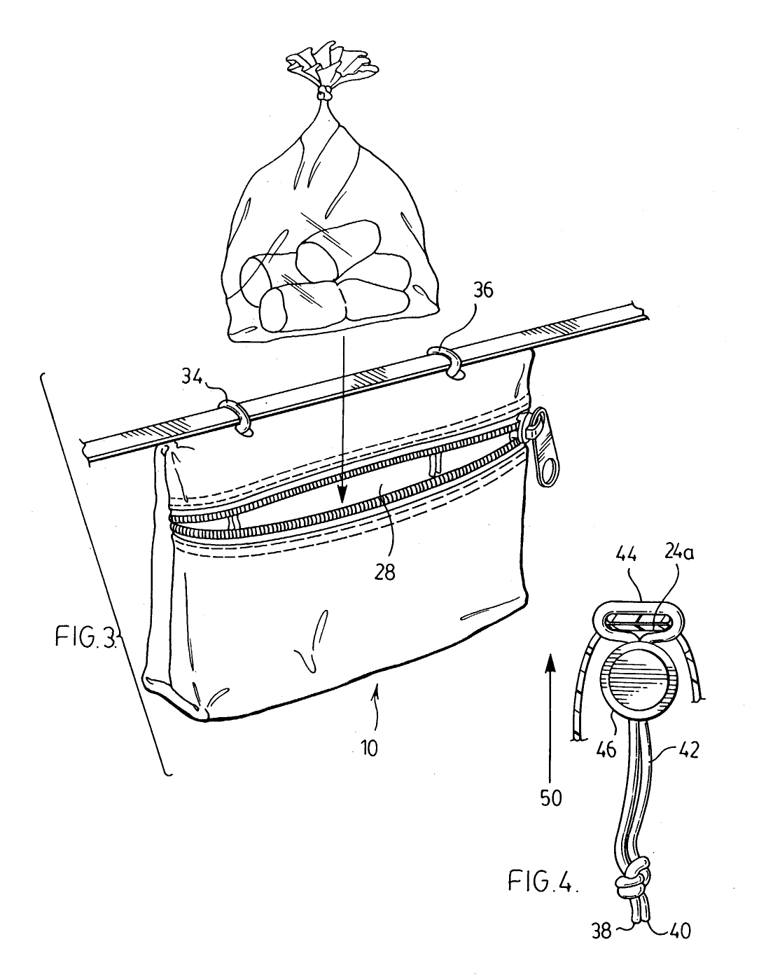

With reference to FIGS. 1 and 2, the pouch of the invention, generally 10, is shown in conjunction with a conventional leash 12 used to lead or control a dog. The leash retracts into a spool within a handle 14 held by the dog's handler 16.

The pouch has a front wall 20, an oppositely facing rear wall (not visible), a top 24 and a bottom 26. A mouth 28 is formed in the front wall to gain access to the interior of the pouch. A zipper 30 serves as the means by which the mouth may be selectively opened and closed.

Apertures 32 are formed in the top of the pouch through which two cords 34, 36 pass With reference to FIGS. 2 and 4, each cord has a pair of ends 38, 40 which are disposed within the pouch and a central portion 42 which extends through the apertures in the top of the pouch and which is formed into a loop 44 outwardly of the pouch.

A toggle 46 is attached to each cord 34, 36. The toggle is of conventional construction and has a plunger 48 biased by resilient means such as a coil spring (not illustrated) within the toggle into gripping contact with the cord to prevent the toggle from moving relative to the cord. Inward pressure on the plunger opposes the bias of the spring and causes the plunger to move out of contact with the cord thereby allowing the toggle to move relative to the cord.

As the toggle moves on the cord, the size of the opening 49 bounded by the loop changes. In FIG. 4 for example, movement of the toggle in the direction of arrow 50 reduces the size of the opening of the loop and squeezes the material 24a at the top of the pouch

In use, the pouch combination is attached to leash 12 by first passing the leash through the loops in the two cords 34, 36. The plungers of the two toggles are then pressed inward in order to allow the toggle to be moved upward and squeeze the leash within the loops. In so doing, the loops tighten around the leash and fix the pouch to the leash so that it cannot be moved. The pouch can then be used to hold the dog's excrement until it can be disposed of in a waste can or the like

The closer the pouch is to the dog, the more the dog will bear the weight of the pouch.

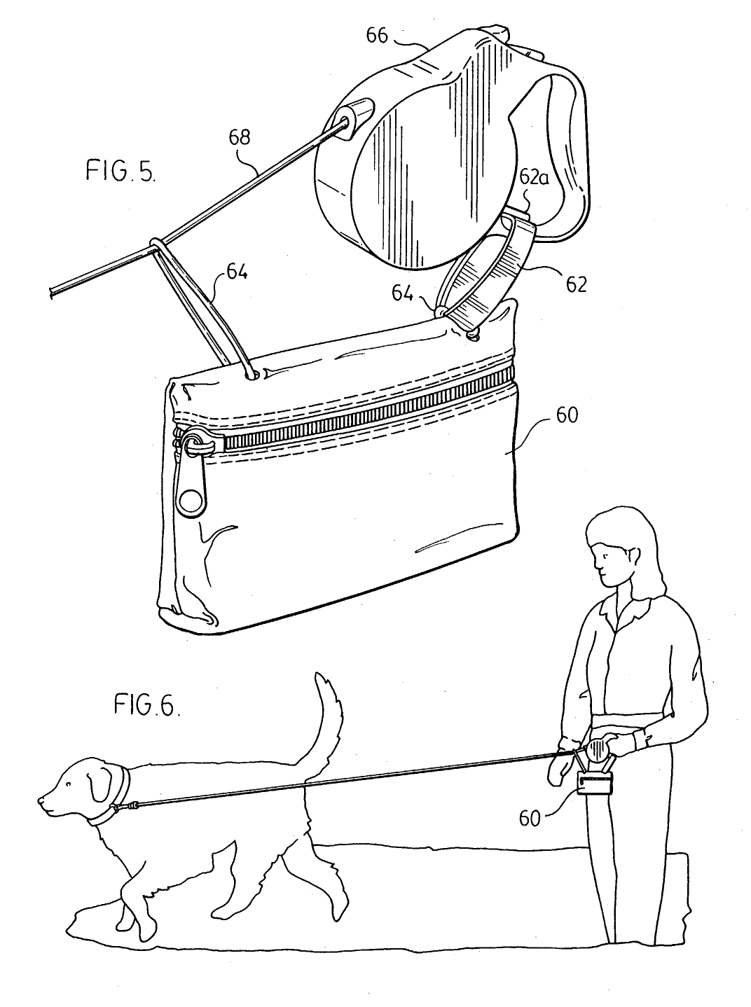

With reference to FIGS. 5 and 6, the pouch 60 has the same construction as pouch 10 of the previous drawings. Two cords, a first one 62 and a second one 64 are attached to the top of the pouch. The first cord has ends (one visible in FIG. 5 and marked 62a) provided with VELCRO or other conventional means so that the two ends may be interconnected to form a complete circle.

The first cord is connected to the pouch by means of a ring 64 which passes through apertures in the top of the pouch. The cord is connected to that ring. The second cord 64 passes through apertures in the top of the pouch in order to connect it to the pouch.

In use, the pouch illustrated in FIGS. 5 and 6 is attached to the handle 66 of a retractable leash by passing the first cord through an opening of the handle. The leash 68 is passed through the second cord so that the pouch is attached both to the handle and to the leash.

Of course, a cord and toggle such as that marked 44 and 46, respectively, in FIG. 2 could be substituted for the first cord 62. In such case, the toggle would be outside the pouch and one end of the cord would be free to be removed from the toggle so that it could be attached to the handle after which it would be re-inserted into the toggle so that the toggle would be effective to tighten the cord to the handle.

The second pouch combination of FIGS. 5 and 6 is useful where the leash is composed entirely of thin twine such as the one illustrated in FIG. 5 and lacks a length of wider cloth such as the one illustrated in FIG. 2. The length of cloth is marked 12a in that Figure. It is possible to attach the first pouch combination to a length of cloth but is more difficult to attach to thin twine because the pouch will tend to slide on the twine. The secured pouch combination being partly attached to the handle will not slide on twine.

It will be understood of course that modifications can be made in the pouch of the invention without departing from the scope and purview of the invention as defined in the appended claims.

We claim:

1. In combination, a pouch for a bag of canine excrement adapted to be removably attached to a leash, said pouch including: oppositely facing front and rear walls, a top and a bottom, said top having a plurality of apertures formed therein, said front wall having an elongated mouth for gaining access to the interior of said pouch and means for selectively opening and closing said mouth; said combination further including a cord having a pair of ends and a central portion, said ends being disposed within said pouch and said central portion being formed into a loop which extends outwardly of said pouch from said aperture; a toggle attached to each said cord for increasing and decreasing the size of an opening defined by said loop, said pouch being adapted to be attached to a leash by first, passing said leash through the opening in said loop and secondly, by causing said toggle to decrease the size of the opening such that said cord tightly engages said leash thereby preventing said pouch from moving on said leash.

2. The combination of claim 1 further including a second cord having a pair of ends and a central portion, said ends being disposed within said pouch and said central portion being formed into a loop which extends outwardly of said pouch from said aperture, said pouch being adapted to be attached to a leash by first, passing said leash through the openings in each said loop and secondly, by causing both said toggles to decrease the size of the openings such that both said cords tightly engage said leash thereby preventing said pouch from moving on said leash.

3. In combination, a pouch for a bag of canine excrement adapted to be removably attached to a leash which is retractable in a handle, said pouch including oppositely facing front and rear walls, a top and a bottom, said front wall having an elongated mouth for gaining access to the interior of said pouch and means for selectively opening and closing said mouth; said combination further including a first circular cord which extends outwardly from said top and adapted to be attached to a leash by attaching said cord to said handle.

4. The combination of claim 3 wherein said first cord has ends which are outside said pouch and which removably interconnect to form a complete circle.

5. The combination of claim 3 wherein said first cord has a pair of ends disposed within said pouch and a central portion formed into a loop which extends outwardly through an aperture formed in said top; said pouch including a toggle attached to said second cord for increasing and decreasing the size of opening defined by said loop.

6. The combination of claim 3 further including a second circular cord which extends outwardly from said top, said pouch being adapted to be attached to a leash, in addition to attaching said first cord to said handle, by passing said leash through an opening defined by said second cord.

7. The pouch of claim 4 wherein said second cord has a pair of ends disposed within said pouch and a central portion formed into a loop which extends outwardly through an aperture formed in said top; said pouch including a toggle attached to said second cord for increasing and decreasing the size of opening defined by said loop.

8. The pouch of claim 5 wherein said second cord has a pair of ends disposed within said pouch and a central portion formed into a loop which extends outwardly through an aperture formed in said top; said pouch including a toggle attached to said second cord for increasing and decreasing the size of opening defined by said loop.

9. The pouch of claim 1 wherein said toggle has a plunger biased by resilient means into gripping contact with said cord to prevent said toggle from moving relative to said cord, said plunger, when inward pressure is applied thereto opposed to the bias of said resilient means, moves out of contact with the cord thereby allowing the toggle to move relative to the cord.

10. The pouch of claim 6 wherein each said toggle has a plunger biased by resilient means into gripping contact with said cord to prevent said toggle from moving relative to said cord, said plunger, when inward pressure is applied thereto opposed to the bias of said resilient means, moves out of contact with the cord thereby allowing the toggle to move relative to the cord.
